(19) United States
(12) Patent Application Publication
(10) Pub. No.: US 2003/0074330 A1
(43) Pub. Date: Apr. 17, 2003

(54) Efficient electronic auction schemes with privacy protection

(75) Inventors: Nadarajah Asokan, Espoo (FI); Valtteri Niemi, Helsinki (FI); Helger Lipmaa, Helsinki (FI)

Correspondence Address: ALTERA LAW GROUP, LLC, 6500 CITY WEST PARKWAY, SUITE 100, MINNEAPOLIS, MN, 55344-7704, US

(73) Assignee: Nokia Corporation, Espoo (FI)

(21) Appl. No.: 10/269,403

(22) Filed: Oct. 11, 2002

Related U.S. Application Data
(60) Provisional application No. 60/328,863, filed on Oct. 11, 2001.

(51) Int. Cl. G06F 17/60

(52) U.S. Cl. 705/80

(57) ABSTRACT

The present invention is for use in an electronic auction and in an electronic second price sealed bid auction. The present invention is an efficient and secure privacy protection method and system that protects the opening of sealed bids during a sealed bid auction and preventing fraudulent attempts. The system includes are bidders, an auctioneer, and a semi-trusted third party, each of which is provided with a terminal or a computer system capable of sending and receiving information. The terminals of the bidders communicate with a computer system of the auctioneer over a first network and the computer system of the auctioneer communicates with a computer system of the semi-trusted party over a second network. The first and second networks are either radio or fixed networks.

### CROSS REFERENCE TO RELATED APPLICATION

This is a non-provisional application claiming the benefit of and priority to U.S. provisional patent application No. 60/328,863 filed on Oct. 11, 2001, which is incorporated by reference.

### FIELD OF THE INVENTION

The present invention relates generally to electronic auctions and more specifically to efficient privacy protection in an electronic second price sealed bid auction.

### BACKGROUND OF THE INVENTION

Electronic commerce has made rapid progress in recent years. Electronic auctions are increasingly popular on the Internet. Several hundred electronic auction houses are in operation today.

Generally speaking, there are various types of auctions, and some of them are described briefly in the following.

FIG. 1 illustrates different types of general auctions. Commonly auctions can be divided into the following two groups: single-sided auctions and double-sided auctions. In single-sided auctions, only one side, i.e., bidders, make bids, whereas in double sided auctions, both sellers and bidders make bids. Single-sided auctions are further divided into the following two groups: open and closed.

Examples of open auctions are English auctions and Dutch auctions. In the former auctions, an ascending price is used and the last remaining bidder wins. Thus, bidding activity stops when bids are not raised anymore, and the bidder who bid the highest price must buy the item at that price. On the other hand, in the latter auctions, a descending price is used. At the beginning, an auctioneer specifies the maximum price or the starting price. After that, the price is descended until a first bidder is willing to pay the current price for the item. These kinds of auctions require many rounds of interactions until the auction duration is complete. In addition, at open auctions, bids are visible to all participants.

Examples of closed auctions or sealed bid auctions are first price sealed bid auctions and second price sealed bid auctions. In the former auctions, the winner is the bidder who is willing to pay the highest bid price. However, in the latter auctions, also called Vickrey auctions, the winner is the bidder who bids the highest price, but the price that the winner has to pay is equal to the second highest bid price. An objective in this type of auction is to induce bidders to bid their true valuations of the goods being for sale. In sealed bid auctions conducted in the real world, bid prices are not visible to other bidders, but the auctioneer finds out all the bid prices.

On the one hand, sealed bid auctions are very efficient when compared to open bid auctions because they require only one round of interaction. Participants submit a sealed bid to the auctioneer, who opens all the sealed bids and selects the winner. Vickrey auctions are shown to be as economically optimal as English auctions. In spite of this, Vickrey auctions are seldom used in auctions. One of the basic reasons for that is lack of bid privacy, i.e., the auctioneer needs to open each one of the sealed bids in order to determine the winning bid. This kind of auction allows cheating by the auctioneer. For that reason, there is a need for a method whereby it is possible to achieve maximum privacy for bidders as protection against corrupt auctioneers.

Some known security problems in electronic auctions are collusion, a ring, and a shill. If some participants co-operate with each other with the object of affecting the outcome of the auction (e.g., bringing down the price of a certain item), it is called collusion. For example, a corrupt auctioneer might collude with some participant. The members of a ring agree with each other not to outbid any of the ring members. Shill is an operation where an auctioneer has arranged a fake bidder for the auction. The fake bidder tries to artificially drive up the price.

Internet auctions constitute a big source of complaints, both from bidders and auctioneers. The primary reasons for complaints are that an auctioneer does not receive payment for the items, a winning bidder is not satisfied with the item bought, and a winning bidder never receives an item.

Several known cryptographic auction schemes are available for ensuring trust and privacy in electronic auctions. Some of them are described briefly in the following.

Christian Cachin, in his article, “Efficient Private Bidding and Auctions with an Oblivious Third Party”, In the Proceedings of the 6^{th} ACM Conference on Computer and Communications Security, ACM Press, 1999, describes a protocol for a sealed bid first price auction. This protocol has two drawbacks. The first drawback is that it cannot be used for Vickery auctions, where the second highest price must also be found. In order to find out the second highest price, the identity of the bidder who bid the second highest bid needs to be revealed, thereby compromising his privacy. The second drawback, in this prior art solution, is that a sub protocol must be run numerous times, because the auctioneer must compare all the bids in pairs in order to reach the final result. The number of communication rounds between the servers for each auction depends on the number of bidders. Thus, this solution is computationally expensive. Therefore, it is neither an efficient nor a suitable solution for Vickrey auctions.

Hiroaki Kikuchi, in his article, “(M+1)st-Price Auction Protocol”, Proceedings of Financial Cryptography 01, Springer, 2001, describes (M+1)st price auctions, in general. The Vickrey auction is a special case with M=1. A significant disadvantage associated with this solution is that the security of the scheme relies on distributing the trust among multiple servers essentially performing the same task. The replicated servers use techniques of threshold cryptography. The meaning of threshold cryptography is that security is assured if the number of trustworthy servers is above a pre-defined threshold. This solution is not viable in applications such as electronic auctions, where there is a constant need for increasing the trust level of the auction process.

If the same auctioneer runs all of the servers, it is clear that there is hardly any increase in the trust level. At least some of the servers should be operated by parties who are more trusted by bidders. On the one hand, if some servers are well-known and highly respectable organizations, a large number of bidders may trust them. On the other hand, the servers of such trusted organizations may quickly develop bottlenecks because they have to handle a large number of auctions of many different auctioneers.

An alternative approach is not via replication, but instead through an asymmetric division of tasks between the auctioneer and a server operated by a third party.

Naor et al., in their article “Privacy preserving auctions and mechanism design”, Proceedings of the 1^{st} ACM Conference on Electronic Commerce, Denver, Colo., 1999, describe a mechanism whereby security relies on two separate servers performing different tasks. The system model used in this approach is more pragmatic than threshold models, due to the asymmetric division of tasks. However, the solution is computationally impractical.

According to the Naor document, at each auction, the servers have to transmit a significant amount of data. The size of this data is directly proportional to the number of bidders and logarithmically proportional to the number of different bid values. As an example, a situation may be described in which a 768-bit El Gamal encryption key is used. In the case of 1000 bidders and 2²⁰ different bid values, the data to be transferred between the servers during the auction is about 2 MB each way. When several auctions are simultaneously in progress, or an auction server is behind a slow communication line, it is obvious that transferring that much data back and forth is not only ineffective, but also costly.

In addition, a large amount of setup data (for the encoded circuit) is needed between the servers before the auction has even begun. A given encoded circuit fixes the number of bidders and the set of bid values. If additional bidders are willing to participate in the auction, a new encoded circuit is needed.

It can be seen that there is a need for an authorized external examiner to audit the auction process and determine that all legal requirements are being met.

It can also be seen that there is a need for an efficient privacy-preserving scheme for Vickrey auctions that overcomes the problems described above.

### SUMMARY OF THE INVENTION

The present invention is for use in an electronic auction. An objective of the present invention is to devise an efficient and secure privacy protection method and system that protects the opening of sealed bids during a sealed bid auction, as well as for preventing fraud.

Users of the system are bidders, an auctioneer, and a semi-trusted third party, each of which has a terminal or a computer system capable of sending and receiving information. The terminals of the bidders communicate with the computer system of the auctioneer either over a radio network or a fixed network via a confidential channel, as does the computer system of the auctioneer and the computer system of the semi-trusted third party. Thus, the auctioneer operates in conjunction with a third party.

The initial set up information required is independent of the size of possible bid values used in the auction. The same set up information can be used in multiple auctions. At the beginning of an auction, an AUCTION ADVERTISEMENT message is broadcast from the computer system of the auctioneer to all the terminals of the bidders. That message at least includes information needed for a highly secure electronic auction, such as, a certificate containing a public encryption key for the semi-trusted third party and another certificate for a public signature verification key for the auctioneer.

In an embodiment of the invention, the terminal of a bidder sends the auctioneer a BID ANNOUNCEMENT message, including the bidder's encrypted bid EBᵢ for an item to be auctioned. The message is signed by the bidder's signing key. The bid is not only encrypted using an encryption key of the semi-trusted third party, but is also hidden by the application of a collision resistant one-way hash function: h(EBᵢ)=h₁. Thus, at this point, no one other than the bidder knows the value of the commitment. The message is a commitment from the bidder to the auctioneer for the amount bid by the bidder. Once a BID ANNOUNCEMENT is sent, the bidder cannot change the value of his bid without being detected. The auctioneer's computer system receives similar messages from a plurality of terminals of the bidders.

In response to the messages received, the collision resistant one-way hash function is applied to the commitments his received to confirm that the auctioneer has received all the commitments. Then, a first confirmation h({hᵢ}) computed in the computer system of the auctioneer is broadcast to the bidders, along with the auctioneer's signature on h({hᵢ}). Each of the bidders, i.e., the terminals of the bidders, checks that the hi sent in the BID ANNOUNCEMENT message is found in the broadcast message.

Provided that the check was successful, the terminals of the bidders send their BID SUBMISSION message, including the encrypted bid EBᵢ, to the auctioneer's computer system. The first task of the computer system of the auctioneer is to check that each encrypted bid EBᵢ matches the commitment received earlier, which should be the result of applying the collision resistant one-way hash function to the encryption: h(EBᵢ)=hᵢ. Thus, the collision resistant one-way hash function is applied to each EBᵢ. If each of the results hᵢ is identical with the previously received his, all the encrypted bids are combined (CB), signed by the auctioneer's signing key, and sent to the semi-trusted third party.

In response to the combined bids received, the computer system of the semi-trusted third party extracts individual encrypted bids EBᵢ and decrypts each of them. In this way, only the semi-trusted third party is able to see the committed bid prices, but nevertheless does not have any information (e.g., signature of a bidder) for linking the bidding prices to any of the bidders. A task of the computer system of the semi-trusted third party is to find out the winning price and identify the encryption of the winner. The winning bid is computed in such a way that possible fraud can be verified either during the auction or subsequently. In addition, the semi-trusted third party confirms that exactly the same bids have been processed throughout the auction process, i.e., neither extra bids nor missing bids are to be found or detected during the processing. A second confirmation to the bidders is computed in the following way: first the collision resistant one-way hash function is applied to each of the encrypted bids, h(EBᵢ)=hᵢ and then applied again to all of the his. The results, with at least the winning price and the identification of the encryption of the winner hidden by the hash function, are included in the RESULT message and sent to the auctioneer. The message is signed by the signing key of the semi-trusted third party.

Now the computer system of the auctioneer can identify who the winning bidder is by linking the respective signature of the bidder with the identification of the encryption of the winner. The information about the winner and the winning price, i.e., the RESULT message, is broadcast to the bidders from the auctioneer's computer system. Then the bidders check the validity of the signature of the semi-trusted third party, as well as whether the first confirmation h({hᵢ}) computed by the computer system of the auctioneer and the second confirmation h({hᵢ}) computed by the computer system of the semi-trusted third party are identical.

In another embodiment of the invention, a homomorphic encryption scheme is used. This embodiment reduces the level of trust required towards the semi-trusted third party. The main difference between the embodiments is that the bids are encoded in a specific way and the encrypted bids EBᵢ received in the BID SUBMISSION messages are combined by multiplying them together in order to ensure that the semi-trusted third party cannot identify the winner. This leads to the situation where the computer system of the semi-trusted third party has to compute specific proof (instead of the second confirmation described above) to the bidders. With this proof, the semi-trusted third party demonstrates that the computation of the winning price has been carried out correctly.

In both embodiments, only at the end of the auction, the final result is published, i.e., the winning bid and the winning bidder (e.g., B₂₆) based on the succession of bids given, for example. Consequently, no personal data of the winner is published. Information about each bid and each bidder is kept secret in such a way that neither the auctioneer nor the semi-trusted third party has enough information to link any bid with its bidder.

### BRIEF DESCRIPTION OF THE DRAWINGS

The invention is described more closely with reference to the accompanying drawings, in which:

FIG. 1 illustrates different types of auctions;

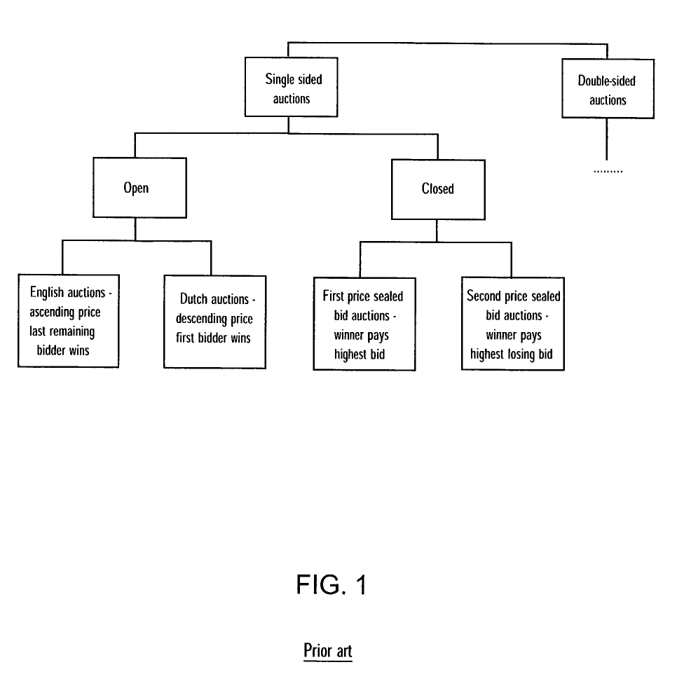

FIG. 2 shows an arrangement of an electronic auction according to an embodiment of the invention;

FIG. 3 illustrates a secure protocol used in an electronic auction according to an embodiment of the invention; and

FIG. 4 illustrates another secure protocol used in an electronic auction according to an embodiment of the invention.

### DETAILED DESCRIPTION OF THE INVENTION

In the following description of the embodiments of the invention, reference is made to the accompanying drawings. However, it will be apparent to those skilled in the art that the present invention may be practiced in other embodiments that depart from these specific details.

The protocol described in the following can be used in many different situations, such as electronic auctions on the Internet or electronic auctions where participants are physically present at the auction house, but make their bids electronically by using a communicator, for example.

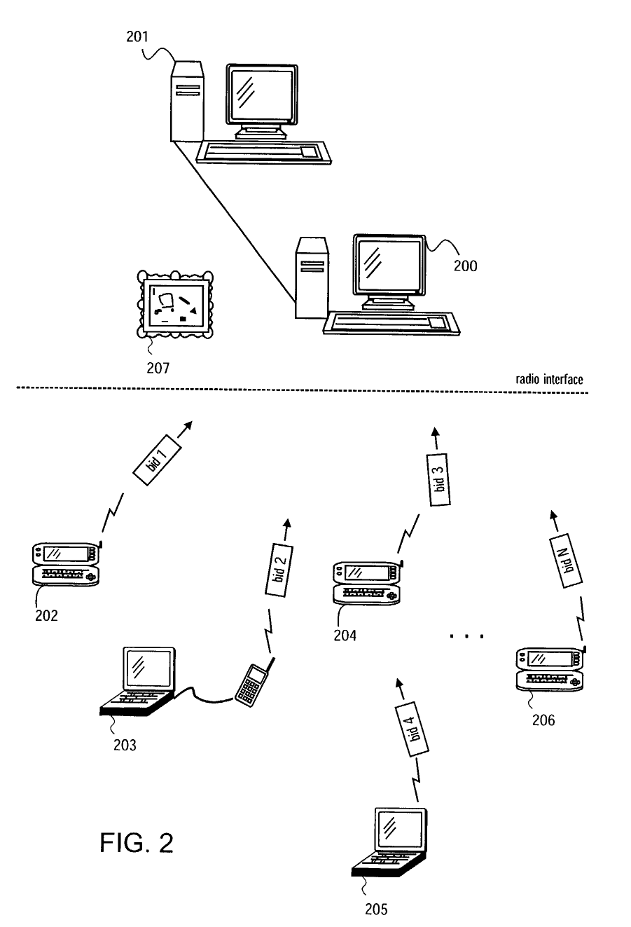

With the aid of FIGS. 2-4, embodiments according to the invention disclose an efficient and secure protocol for use in an electronic auction.

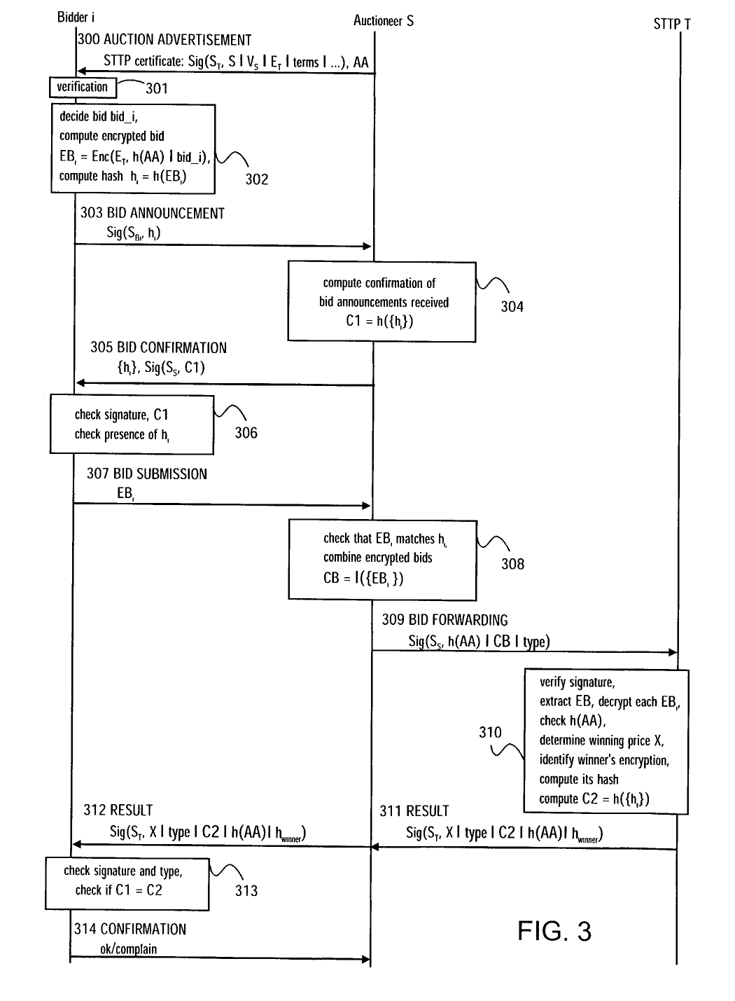

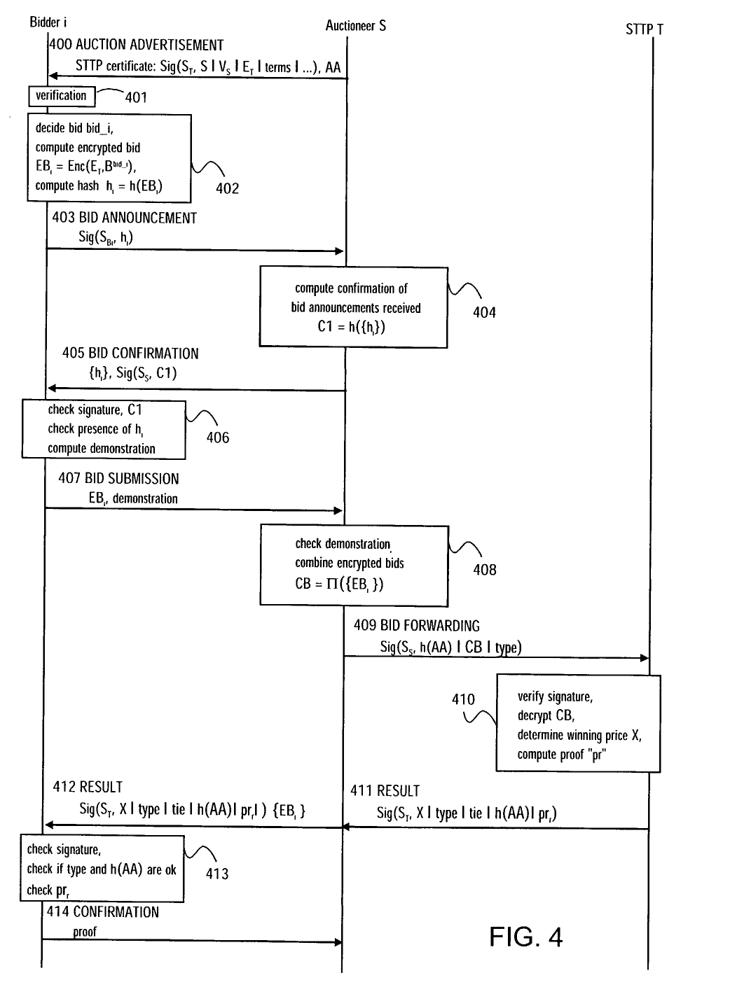

FIG. 2 shows an arrangement for electronic auctions in accordance with the invention. A general idea is first briefly described here. A plurality of bidders Bᵢ, present in an auction house, bid for a piece of art 207 by using terminals, such as mobile phones, communicators, or laptop computers, including a WLAN-card (Wireless Local Area Networks) 202-206. Encrypted bids (bid 1-bid N) are sent through the radio interface to the auctioneers computer system, which is capable of sending and receiving information 200 and including at least an application server. However, the system may also include a web server. The auctioneer's computer system processes the bids received and forwards the processed bids to the computer system of the semi-trusted third party 201 for further processing. The third party's computer system includes at least an application server. In practice, the servers of the auctioneer and of the semi-trusted third party are at different locations. They communicate with each other either through a fixed network or through the radio network. The processing of the bids, both by the auctioneer and by the semi-trusted third party, are described in detail with reference to FIGS. 3 and 4. Information about a bid and a bidder is encrypted in such a way that neither the auctioneer nor the semi-trusted third party alone can link any bid with its bidder. All the bids are kept secret throughout the auction activity, including the highest bid. Thus, no bid is revealed to anyone except the second highest bid at the end of the auction, when the final result is broadcast from the auctioneer's computer system. The protocol used does not require a trusted party, but a semi-trusted third party. When the combination of a semi-trusted third party and secure cryptographic tools is used, this leads to a situation where the computer system of the auctioneer can identify the winner without any need to open any of the sealed bids.

The level of privacy offered by the protocol according to the invention is high. Besides this, the protocol is fast, i.e., it requires only one round of communication between the auctioneer and the semi-trusted third party.

FIG. 3 illustrates a protocol used between the units described above. As an example, consider a sealed bid second price electronic auction or an electronic Vickrey auction, where bidders are present at an auction house. The bidders have an opportunity to examine goods beforehand, in which case making a true valuation of the goods is easier than in Internet auctions, for example.

The initial set up information required before the auction begins is independent of the size of all the possible bid values. However, the same set up information can be used in multiple auctions. Every private message between the terminals of the individual bidders and the computer system of the auctioneer are transmitted via a confidential channel. Of course, messages between the computer system of the auctioneer and the computer system of the semi-trusted third party are also transmitted via a confidential channel. The confidential channel is created by using a suitable protocol, such as SSL/TSL (Secure Socket Layer/Transport Layer Security) or WTLS (Wireless Transport Layer Security). No restrictions on the number of bidders or the size of bids are required in this method.

Initially, all bidders are expected to have a trusted copy of semi-trusted third party's T signature verification key V_{T}. The signature verification key is a public key and thus the way in which bidders receive that key is not essential for the invention. In addition, the auctioneer has a trustworthy copy of the signature verification key V_{Bi} of each of the authorized bidders. The auctioneer receives the keys when registering for the electronic auction. Alternatively, bidders may be charged an entry fee for participating in the auction and required to provide their public key at the same time. The auctioneer receives a certificate from the semi-trusted third party T. The semi-trusted third party T has the signature verification key V_{S} of the auctioneer (or of several auctioneers) with whom T has an agreement.

At the beginning of the auction, an AUCTION ADVERTISEMENT message 300 is broadcast from the computer system of the auctioneer to all participants. The AUCTION ADVERTISEMENT message consists of a certificate issued by the semi-trusted third party T and an auction announcement AA. The certificate includes at least the public encryption key E_{T} of the semi-trusted party T and the public signature verification key V_{S} of the auctioneer S. The certificate is digitally signed by the signing key S_{T} of the semi-trusted third party STTP T.

However, other information can also be included, such as the name S of the party conducting the auction, the item being auctioned, a time limit for a response, a transaction identifier which can be used by T to detect replays of encrypted bids, a collision resistant one-way hash function, rules to be followed, and the duration of the certificate, for example, “This certificate is valid until December 2001”. “One-way hash function” is the shortened term used hereinafter for the collision resistant one-way hash function. An auction announcement AA contains information characterizing and uniquely identifying the auction and the type of the auction, such as a Vickrey auction.

The auction announcement AA may be signed by the auctioneer S with the signing key S_{S} of the auctioneer. All of the bidders Bᵢ who want to participate in the auction verify the certificate by T's public signature verification key V_{T}, at stage 301.

Suppose bidder Bᵢ wants to buy a piece of art 207 and decides to bid bid_i dollars. At stage 302, the amount of the bid (bid_l) with h(AA), (the auction announcement AA is hidden by a one-way hash function h( )) is encrypted using the encryption key E_{T} of the semi-trusted third party T. This means that only the semi-trusted third party T can decrypt the encrypted bid E_{Bi}=(E_{T}, h(AA), bid_i). In addition, a one-way hash function h( ) is applied to EBᵢ: hᵢ=h(EBᵢ). Then hi is signed by the signing key S_{Bi} of the bidder Bᵢ and sent in a BID ANNOUNCEMENT message 303 to the auctioneer S.

This message serves as a commitment by the bidder to his bid amount, without actually revealing the bid amount to anyone. Each of the given bids from other bidders is processed in the same way. Standard cryptographic tools can be used for encoding and decoding.

The computer system of the auctioneer S receives BID ANNOUNCEMENT messages. However, the auctioneer S (or even the semi-trusted third party T) cannot ascertain any bid values because the BID ANNOUCEMENT contains only a commitment and not the actual bid itself. A one-way hash function is easy to compute in one direction, but computation backward is unfeasible. A collision resistant one-way hash function has the additional property that it is unfeasible to find two inputs x and y such that h(x)=h(y). All commonly used one-way hash functions are also collision resistant.

The computer system of the auctioneer S collects all the BID ANNOUNCEMENT and computes the first confirmation C1=h({hᵢ}) to the bidders at stage 304. The confirmation C1 is computed so that first all his are concatenated and then the one-way hash function is applied to the concatenated hᵢs: h({hᵢ})=C1. The BID CONFIRMATION message 305 including C1 is signed by the signing key S_{S} of the auctioneer S and broadcast to the bidders. Additionally, an individual receipt could be issued for each bidder by the auctioneer S.

At stage 306, each of the bidders has the possibility to check that the auctioneer S has received the bid information correctly, i.e., it is checked that each bidder's hᵢ is in the BID CONFIRMATION message list and that the signature S_{S} is valid. As a matter of fact, the terminal of the bidder performs the checking automatically, as well as the main part of transaction between the computer system of the auctioneer and the terminal of the bidder. The user of the terminal is informed of the progress of the protocol by brief messages on the display, such as, “confirmation received”, for example. When the broadcast message includes the sent bid announcement, the bidder verifies the signature by sending a BID SUBMISSION message 307, including the encrypted bid EBᵢ.

First, the computer system of the auctioneer S checks that each EBᵢ matches each hᵢ at stage 308. Checking is performed by applying to each EBᵢ the same hash function as the bidder applied at stage 302. The reason for steps 303-308 is to eliminate the possibility of falsely adding or deleting a bid during the auction activity. Even the auctioneer S does not know the content of the encrypted bids because the encryption key of the semi-trusted third party T is used to encrypt them. Thus, only the semi-trusted third party T is capable of opening the submitted bids. Next, if matching was successful, the computer system of the auctioneer S combines the encrypted bids using a combination function f({EBᵢ})=CB. In the simplest case it is a concatenation function.

If an encryption bid is missing, the auction is cancelled. In this case, the auctioneer S is able to identify the bidder who did not send an encrypted bid because the corresponding BID ANNOUNCEMENT received earlier was signed by the bidder. Otherwise, combined encrypted bids CB are forwarded to the semi-trusted third party T in a BID FORWARDING message 309 signed by the auctioneer's signing key S_{S}. Besides the combined encrypted bids CB, the message includes such information as, the h(AA), and the type of the auction, e.g., the second price sealed bid auction, for example.

At stage 310, the computer system of the semi-trusted third party T receives the message, and the signature of the auctioneer S is verified. Then, the computer system extracts the combined encrypted bids CB, decrypts each of the encrypted bids EBᵢ, and checks whether the h(AA) confirms that the auctioneer S and the bidders are participating in the same auction. Actually, the semi-trusted third party T never knows the auction announcement AA because the use of a one-way hash function guarantees that h(AA) does not reveal any information about AA.

The semi-trusted third party T is now able to see all the bid values but cannot link any bid value to the corresponding bidder because the signature that identifies the bidder is not forwarded from the auctioneer S. As already stated in the second price sealed bid auction or Vickrey auction, the winning bid is the second highest bid, but the winner is the bidder whose bid has the highest value. Thus, the computer system of the semi-trusted third party T determines the winning price X, i.e., the second highest price.

When there is more than one highest price, the winner can be determined in several ways. One such way is that the winner is simply the bidder who bid first. Alternatively, the winner can be selected by lot. However, if there are more than one of same winning price, the computer system of the semi-trusted third party T does not decide which one of those bidders is the winner, but leaves the decision to the auctioneer S. Actually, the method for processing the selection of the winner can be reported in the AUCTION ADVERTISEMENT message.

The computer system of T computes a confirmation C2 by applying a one-way hash function h( ) to each of the encrypted bids h(EBᵢ)=hᵢ and then again to all of the hᵢs. The reason for computing C2 is to give the bidders a possibility to compare whether C1 and C2 are equal. This is necessary to ensure that no fraud has happened during the auction activity. On the one hand, C1 and C2 are used to ensure that all the bids have been sent and on the other hand that there are no extra bids or missing bids. Eventually, the winner's encryption is identified, and the one-way hash function is applied to it. The result is marked here as h_{winner}.

Then h_{winner} is signed along with the winning price X, the auction type, C2, h(AA) and the signing key S_{T} and sent in a RESULT message 311 to the auctioneer S. At stage 312, the result is broadcast to the bidders by the auctioneer. At this point, the auctioneer S can also identify who is the winning bidder.

When the terminals of the bidders receive the RESULT message, they check the validity of the signature of T, the type of the auction, as well as whether confirmations C1 and C2 are identical, stage 313. In response to the message, the bidders send a CONFIRMATION message 314 for confirming whether the result is allowed or disallowed. In the latter case, a bidder has lodged a complaint.

In order to preserve privacy, it is important that the prices bid and the bidders cannot be linked together by either the auctioneer S or the semi-trusted third party T, but that the bids are kept secret throughout the auction. Of course, the winner and the second highest price are reported when the bidding contest is terminated. No personal data of the winner is published, but simply the number of the bidder (e.g., B₂₆) based on the succession order of the bidding, for example.

The above-described method has many advantages. One is that no restrictions on the number of bidders or the number of possible bid values are required. Another advantage is that the method is efficient. The terminal of each the bidder has to compute one encryption and one signature, and verify a constant number of signatures. The computer system of the auctioneer verifies N+1 signatures, (N is the number of bidders), and then computes two signatures, or alternatively N+2 signatures, if individual bid announcements are confirmed separately. The computer system of the semi-trusted third party computes N decryptions and verifies a constant number of signatures. Still another advantage is that an audit can be performed on the semi-trusted third party by an authorized external examiner. This can be done randomly and/or on demand if a bidder or auctioneer complains.

FIG. 4 illustrates another efficient secure protocol used in an electronic Vickrey auction. Steps 400-401 in FIG. 4 correspond to steps 300-301 in FIG. 3. At stage 402, bid_i is specifically encoded. First, it is assumed that n is the maximum possible number of bidders. Next, a number B>n is chosen and raised to the power bid₁₃ i: B^{bid}^{_{—}}ⁱ. Using a homomorphic encryption scheme, the number B^{bid}^{_{—}}ⁱ is encrypted by the encryption key E_{T} of the semi-trusted third party: Enc(E_{T}, B^{bid}^{_{—}}ⁱ)=EBᵢ. Thereafter, the encrypted bid EBᵢ is hidden by a one-way hash function h( ) in the same manner as in FIG. 3, with the exception of auction announcement AA. Then, hi is signed by signing key S_{Bi} and sent in a BID ANNOUNCEMENT message to the auctioneer S at stage 403. Steps 404-405 in FIG. 4 correspond to steps 304-305 in FIG. 3.

At stage 406, the bidder submits a bid including a cryptographic demonstration proving that the encryption EBᵢ contains a valid bid bid_i. The demonstration is a range proof that consists of a sequence of numbers and can be verified by the auctioneer during the auction. However, in case of conflict, the demonstration can also be verified after the auction by a judge, for example. The bid submission is sent in BID SUBMISSION message 407 to the auctioneer S. In response to the message received, the validity of the demonstration is checked at stage 408.

Unlike in the first embodiment of the invention, the computer system of the auctioneer does not combine all bids received by concatenating them, but rather, by exploiting a property of the homomorphic encryption scheme used to construct the encrypted bids. The idea of the homomorphic scheme is briefly described in the following. If two encryptions are encrypted with the same key, these encryptions can be multiplied and the result is still a valid encryption of the addition of the two corresponding plaintexts. That is in mathematical form: Enc(X)×Enc(Y)=Enc(X+Y). Generally speaking, the formula is also valid for more than two encryptions.

Thus, all encrypted bids received are combined by multiplying them. The result of multiplication is a single encryption CB=π({EBᵢ}), which is sent to the semi-trusted third party T, together with h(AA) and information about the type of auction, in a signed (with the signing key of the auctioneer) BID FORWARDING message 409. At stage 410, in response to the message received the semi-trusted third party T verifies the signature S, and the CB is decrypted. The result of decryption is a number having the following form:

$${\sum }_{j = 1}^{m} {a}_{j} {B}^{j} ; \qquad ( 1 )$$

where aⱼ(<n<B) is the number of bidders who bid the amount j. The computer system of the semi-trusted third party T determines the winning price X, as the second highest j value in equation (1) such that the corresponding coefficient aⱼ is non-zero, but now the winner cannot be identified because of a lack of individual encryptions. However, in order to ensure that the computation of the winning price X is correct, the computer system of the semi-trusted third party T computes a proof pr as follows.

Suppose that the decrypted CB or equation (1) is a plaintext P. Let Z1=B^{X} and Z2=Bhighest, where highest is the value of the highest bid, i.e., the highest j value in the equation (1) such that the corresponding coefficient aⱼ is non zero. Then T computes as follows;

Z3=P−Z1−Z2, (2);

in addition, three encryptions are needed;

X1=Enc(E_{T}, Z1) (3);

X2=Enc(E_{T}, Z2) (4);

and

X3=Enc(E_{T}, Z3) (5).

The proof pr is computed for demonstrating that:

a) X1 is an encryption of B^{X};

b) X3 is an encryption of a value less than B^{X+1}; and

c) X2 is an encryption of some value not less than B^{X+1}.

In order to verify that the winning price X is computed correctly, a verifier, such as a bidder or the auctioneer, checks whether CB is the product of X1, X2, and X3 and whether the proof pr is correct. Steps 411-413 in FIG. 4 correspond to steps 311-312 in FIG. 3, except that in place of C2, there is the proof prᵣ. At this point, the auctioneer server is not capable of identifying the winning bidder yet. However, another difference from FIG. 3 is that the auctioneer server includes all bids received at stage 408 in the RESULT message 412.

Due to the combining method at stage 408, a hash h(AA) cannot be included in the encrypted bid EBᵢ at stage 402. In order to prevent reduction of security, a special safeguard can be implemented. Thus, a corrupt auctioneer cannot send an encrypted bid from a different auction, for example.

One way to implement such a safeguard is described in the following. Normally the public key encryption is performed so that there is a hidden random input for randomizing the encryption. This randomizer can be used to bind the encrypted bid EBᵢ to the h(AA) to prevent reuse of the bid. Thus, the bidder must send two different encryptions:

EBᵢ=Enc(E_{T}, rᵢ, B^{bid}^{_{—}}ⁱ) (6);

and

CEBᵢ=Enc(E_{T}, rᵢ, h(AA)) (7);

where rᵢ is the randomizer used in computing the encryption EBᵢ, and CEBᵢ is a check encryption. When the encrypted bid submissions are combined by the computer system of the auctioneer, the results are:

CB=π(EBᵢ)=Enc(E_{T}, r, Σ B^{bid}^{_{—}}ⁱ) (8);

and

CCB=π(CEBᵢ)=Enc(E_{T}, r, Σ h(AA)ⁱ) (9);

respectively, r is deterministically derived from the set of rᵢ values. When the computer system of the semi-trusted third party T receives CB and CCB, it should be verified that;

a) the decryption of CCB is a multiple of h(AA); and

b) the randomizer used in CB and CCB is the same.

When comparing this embodiment with the first embodiment, it can be seen that the latter provides a higher level security. However, additional proofs needed increase the communication costs.

It is to be noted that in both embodiments, the auction announcement AA should include a transaction ID that can be easily checked by the semi-trusted third party T, which prevents the auctioneer S from trying to fraudulently retransmit encrypted bids from a different auction, for example.

The tie-break mechanism is independent of the protocols according to the invention. In the homomorphic scheme, the semi-trusted third party could identify the presence of a tie by setting a flag in the result. However, the proof at stage 414 differs then from the above. On the one hand, each of the winners must prove that the encrypted bid EBᵢ sent was the same as the winning price X. On the other hand, each of the losers must prove that the encrypted bid EBᵢ sent was less than the winning price X. The stage 414 is needed so that the auctioneer is able to charge the winner for the accepted bid. It is to be noted that in neither of the embodiments above, did the semi-trusted party, at any stage, find out who is the winner.

The implementation and embodiments of the present invention have been explained above with various examples. However, it is understood that the invention is not restricted by the details of the embodiments above and that numerous changes and modifications can be made by those skilled in the art without departing from the characteristic features of the invention.

The embodiments described are to be considered illustrative, but not restrictive. Therefore, the invention should be limited only by the attached claims. Thus, alternative implementations, defined by the claims, as well as equivalent implementations, are included in the scope of the invention. For example, some functions can be in a different order. The messages mentioned here are just examples, and there can be many kinds of messages. The tasks that computer systems perform automatically can vary, i.e., some tasks may be performed in accordance with instructions of the user. An item to be auctioned may be a product or a service. Further, the invention is not bound to any specific technology.

1. A method for protecting data in an electronic on-line auction system having an auctioneer server operating in conjunction with a server of a third party adapted to handle bids, and communicating with a plurality of user terminals, the method comprising:
receiving from the user terminals via a first network a number of messages, each message including a bid encrypted with an encryption key of the third party;
sending via a second network a message including received encrypted bids to the server of a third party;
decrypting at the server of a third party the encrypted bids and discovering a value of a winning bid;
forming at the third party server a result message including the value of the winning bid; and
sending the result message to user terminals via the auctioneer server.

2. The method according to claim 1, further comprising:
identifying at the user terminals the value of the winning bid and based on information received in the result message a user terminal identifying itself as the terminal corresponding to the winning bid.

3. The method according to claim 1, further comprising:
prior to receiving the encrypted bids from the user terminals forming at the auctioneer server a first confirmation function by applying a one-way hash function to a combination of commitment messages received via a first network from the user terminals, each commitment message including a protected bid resulting from an application of a one-way hash function to the encrypted bid; and
sending a bid confirmation message including a confirmation function via the first network to the user terminals.

4. The method according to claim 1, further comprising:
prior to sending via the second network the message including the received encrypted bids to the server of the third party, receiving from the user terminals protected bids resulting from an application of a one-way hash function to the encrypted bid;
receiving the encrypted bids;
generating hashed bids by applying the one-way hash function to each of the encrypted bids;
comparing the protected bids with the hashed bids; and
concatenating all the received bids if a comparison is successful, otherwise terminating an auction process upon an imperfect matching.

5. The method according to claim 1, comprising:
receiving from each of the user terminals the encrypted bid;
demonstrating and verifying that content of the encrypted bid is uncorrupted; and
verifying validity of the demonstrating and if verification is successful multiplying the encrypted bids using a homomorphic scheme, otherwise terminating the auction process upon imperfect validity.

6. The method according to claim 1, further comprising broadcasting, at the beginning of an auction, an auction message from the auctioneer server to the user terminals, the auction message at least including a certificate issued by the third party to the auctioneer and an auction announcement for the auctioneer server.

7. The method according to claim 6, wherein the certificate at least includes a public encryption key of the third party server and a public signature verification key of the auctioneer server.

8. The method according to claim 6, further comprising receiving the auction announcement from the auctioneer server at the user terminal;
hashing the auction announcement with the one-way hash function; and
sending the auction announcement together with a protected bid resulting from encryption of a bid with an encryption key of the third party server and application of a one-way hash function to the encrypted bid.

9. The method according to claim 6, further comprising characterizing and uniquely identifying the auction and a type of the auction via information included in the auction announcement.

10. The method according to claim 1, further comprising determining the winning bid at the auctioneer server.

11. The method according to claim 1, further comprising determining the winning bid at the auctioneer server after receiving an additional message from a user terminal corresponding to the winning bid.

12. The method according to claim 1, further comprising applying a one-way hash function being collision resistant.

13. The method according to claim 1, requiring before the auction that at least part of an initial set-up information being reusable.

14. The method according to claim 2, further comprising:
embedding a second confirmation function into a result message via application of a one-way hash function to each of the encrypted bids during forming a result message at the third party server; and
applying another hashing function.

15. The method according to claim 14, further comprising verifying conformity of a first and second confirmation function at the user terminals.

16. The method according to claim 5, further comprising checking correctness of the demonstrating by the auctioneer server.

17. The method according to claim 16, further comprising:
computing a proof by the server of the third party;
verifying the validity of the proof; and
sending the proof with the result message to the user terminal.

18. The method according claim 14, further comprising:
forming independently from each other a first and second confirmation function;
guaranteeing failure of an attempt to add a bid;
guaranteeing failure of an attempt to delete a bid; and
guaranteeing failure of an attempt to change a bid.

19. The method according to claim 1, further comprising at least one of the networks for conducting auction activity being a radio network.

20. The method according to claim 1, further comprising at least one of the networks for conducting auction activity being a fixed network.

21. The method according to claim 1, further comprising authenticating a message sent over a network for conducting auction activity.

22. The method according to claim 1, further comprising signing a message sent over a network for conducting auction activity.

23. An electronic on-line auction system including:
first and second networks;
a plurality of user terminals;
an auctioneer server;
a third party server, the third party server adapted to handle bids, communicate with the plurality of user terminals, and operate in conjunction with the auctioneer server;
circuitry for receiving from the plurality of user terminals a number of messages via a first network, each of the messages including a bid encrypted with an encryption key of a third party;
circuitry for sending a message to the third party server via a second network, the message including all received encrypted bids;
circuitry for decrypting encrypted bids and discovering a value of a winning bid;
circuitry for forming a result message, the result message including the value of the winning bid; and
circuitry for sending the result message to the plurality of user terminals via the auctioneer server.

24. The electronic on-line auction system according to claim 23, further comprising:
circuitry for forming a first confirmation function by applying a one-way hash function to a combination of commitment messages received via the first network from the user terminals, the commitment messages including a protected bid resulting from application of a one-way hash function to the encrypted bid; and
circuitry for sending a first confirmation function to the plurality of user terminals via the first network.

25. The electronic on-line auction system according to claim 23, further comprising:
circuitry for receiving from the plurality of user terminals a protected bid resulting from application of a one-way hash function to the encrypted bid;
circuitry for receiving and applying the one-way hash function to the encrypted bids; and
circuitry for comparing protected bids and hashed encrypted bids, wherein if the protected bids and the hashed encrypted bids match perfectly, all the received bids are concatenated, otherwise, upon imperfect matching, an auction process is terminated.

26. The electronic on-line auction system according to claim 23, further comprising:
circuitry for receiving from the plurality of user terminals the encrypted bid and a proof that content of the encrypted bid is uncorrupted; and
circuitry for verifying the validity of the proof, wherein if verification is successful, multiplying the encrypted bid using a homomorphic scheme, otherwise terminating an auction process upon imperfect validity.

27. The electronic on-line auction system according to claim 23, further comprising means for auditing a third party by an authorized external party.

28. A user terminal for communicating with an auctioneer server via a confidential channel in a first network, the user terminal comprising:
means for sending a message, the message including a bid encrypted with an encryption key of a third party; and
means for receiving from the third party via the auctioneer server a result message, the result message at least including a value of a winning bid, a confirmation function and an identification of an encrypted winning bid, wherein a user terminal recognizes itself as a winner from a result message received.

29. The user terminal according to claim 28, further comprising:
means for computing an encryption for a bid by using an encryption key of the third party;
means for hashing the encrypted bid;
means for sending at least a hashed encrypted bid to the auctioneer server;
means for receiving a further confirmation function formed by applying a one-way hash function to a combination of commitment messages sent via the first network from user terminals participating in an auction, each commitment message including a protected bid resulting from application of a one-way hash function to the encrypted bid; and
means for checking that the further confirmation function and the confirmation function are computed from same bids given; and
means for checking that the value of the winning bid is valid.

30. A user terminal for communicating bids with an auctioneer server over an electronic communications network, the user terminal comprising:
circuitry for transmitting a message having a bid encrypted with an encryption key of a third party:
circuitry for receiving a result message from the third party via the auctioneer server, wherein the result message includes encrypted information identifying whether the user terminal sent a winning bid.

31 An electronic auction system comprising:
user terminals communicating over a first communications network with an auctioneer server and the auctioneer server communicating with a third party server over a second communications network;
user terminals sending messages to the auctioneer server, each message having a bid encrypted with an encrypted key of the third party server;
the auctioneer server communicating the encrypted bid to the third party server which determines a value of a highest bid and returns in a result message to the auctioneer server an identity of an encryption of a winning bidder corresponding to the value of the highest bid.

32. The electronic auction system according to claim 31, wherein the third party server is agreed upon by the user terminals and auctioneer server.

33. The electronic auction system according to claim 31, wherein the auctioneer server can identify and broadcast to a winning bidder and corresponding user terminal.

34. The electronic auction system according to claim 31, wherein the auctioneer server is not able to identify a winning bidder from an encrypted identity in a result message, wherein the result message is sent with a proof parameter to the user terminals so that a user terminal is able to identify itself as a terminal corresponding to a winning bidder.

35. The electronic auction system according to claim 31, wherein the user terminal corresponding to a winning bidder is sent information of a highest losing bid.

36. A method for protecting data in an electronic on-line auction system having an auctioneer server operating in conjunction with a third party server adapted to handle bids, and communicating with a plurality of user terminals, the method comprising:
receiving from user terminals via a first network a number of messages, each message at least including a bid encrypted with an encryption key of a third party;
sending via a second network a message including all received encrypted bids to the third party server;
notifying at least one user terminal of a winning bid.
